(19) United States
(12) Patent Application Publication
(10) Pub. No.: US 2015/0126070 A1
(43) Pub. Date: May 7, 2015

(54) APPARATUS FOR POWERING AN ELECTRONIC DEVICE IN A SECURE MANNER

(71) Applicant: Sony Corporation, Tokyo (JP)

(72) Inventor: Brant L. Candelore, San Diego, CA (US)

(73) Assignee: SONY CORPORATION, Tokyo (JP)

(21) Appl. No.: 14/072,587

(22) Filed: Nov. 5, 2013

(51) Int. Cl. H01R 33/90

(52) U.S. Cl. CPC H01R 33/90
USPC 439/628

(57) ABSTRACT

According to one embodiment of the invention, a portable adapter for an electronic device charger is described. Such an adapter comprises a plug, a receptacle and a socket device wherein the adapter is configured to connect to one of a plurality of standardized connectors such as a Universal Serial Bus (USB). Herein, the socket device includes a plurality of contacts such that none of the plurality of contacts allow for the transfer of data and at least one of the first plurality of contacts is configured for a transfer of power allowing the electronic device to obtain an electrical charge while preventing the transfer of data between the electronic device and the electronic device charger.

### FIELD

Embodiments of the disclosure relate generally to the field of portable electronic device charging. More particularly, one embodiment of the disclosure relates to an apparatus for charging an electronic device through the use of an adapter or cable that is configured to receive power and restrict the flow of data from a connector during the charging of the electronic device at various, potentially unsecure locations.

### BACKGROUND

Portable electronic devices have become ubiquitous in today's society. The term “portable electronic device” should be construed broadly to cover all portable devices that require a power supply in order to operate. Common examples include a cellular telephone (cell phone) such as a Sony® Xperia™, or a portable music player with the ability to store data files or connect wirelessly to the Internet such as Sony® Walkman® digital media player. These devices require a constant source of power which means users are often seeking electrical outlets or electronic devices in order to charge their devices' batteries and continue their usage.

When users are utilizing secure and trusted power supplies, such as a user's personal computer or electrical sockets in a user's home, there is little risk of a compromise in a device's security. However, users often find themselves with little or no battery power without a trusted power supply from which to charge their devices. Therefore, users often turn to charging their devices by the nearest electrical socket, a public computer, or even a computer of a third person. While this may allow the user to obtain the charge required to continue using the device, there is no guarantee that the device's security was not compromised in the process. This compromise of security could entail data being downloaded from the device and stored for later use by a third party or data being uploaded to the device.

Users rarely think about the potential dangers of plugging their devices into an unknown charging station. For instance, malware may be installed on an electronic device, such as a cell phone for example, while the device is plugged into a charging station. Electronic devices often contain passwords to restrict access to the device as well as safety precautions written into the software or firmware. The passwords and precautions are not guaranteed to prevent malware as a hacker can often exploit vulnerabilities in poorly designed software or firmware running on the device to bypass its security. Once loaded, malware, among other things, might access the device's data which may contain personal information such as credit card numbers and bank account numbers, personal contacts, or personal pictures and videos.

Finally, users understand the need to frequently charge their devices and many carry around the requisite cables. However, users are lacking the ability to ensure that, even while using their personal charging cables, no data is being transferred to or from their devices while the devices are charging. Hence, there is a need for a user to be able to both prevent a transfer of data to and from his or her device while it is charging and maintain the convenience of being able to charge the device from any available power supply.

### BRIEF DESCRIPTION OF THE DRAWINGS

The present invention is illustrated by way of example, and not by way of limitation, in the figures of the accompanying drawings and in which:

FIG. 1A illustrates an embodiment of a portable adapter which is placed on a connector when charging an electronic device.

FIG. 1B illustrates an embodiment of a portable adapter connected to a standard A Universal Serial Bus (USB) connector.

FIG. 1C illustrates an embodiment of a standard A Universal Serial Bus (USB) connector connected to an adapter allowing the USB connector to obtain a power supply directly from an electrical socket.

FIG. 1D illustrates an embodiment of a standard A Universal Serial Bus (USB) connector connected to a first adapter connected to a second adapter allowing the USB connector to obtain a power supply from an electrical socket.

FIG. 2 illustrates an embodiment of a portable adapter including a switch connected to a standard A Universal Serial Bus (USB) connector.

FIG. 3A illustrates an embodiment of a cable including a plurality of adapters.

FIG. 3B illustrates an embodiment of a cable including an adapter comprising a plurality of receptacles is depicted.

FIG. 4A illustrates an embodiment of a standard A Universal Serial Bus (USB) connector.

FIG. 4B illustrates an embodiment of a connector including a plurality of contacts.

FIG. 5A is a block diagram illustrating a standard A Universal Serial Bus (USB) cable pinout.

FIG. 5B is a block diagram illustrating a pinout of a charging cable having only two wires both for supplying power while having four contacts, two for supplying power and two for transferring data.

FIG. 6A is an embodiment of the display screen of a cell phone illustrating a notification pop-up requiring the user to choose whether the power supply is trusted.

FIG. 6B is an embodiment of the display screen of a second cell phone illustrating the icon representing the application for disabling data transfer while the cell phone is charging is open.

FIG. 6C is an embodiment of the display screen of a cell phone illustrating the ability of a user to adjust alerts from the application for disabling data transfer while the cell phone is charging and the presence of the application's icon in the Settings menu.

FIG. 6D is an embodiment of the display screen of a cell phone illustrating ability of the user to adjust alerts from the application for disabling data transfer while the cell phone is charging and the presence of the application's icon in the Settings menu.

### DETAILED DESCRIPTION

In the following description, for the purposes of explanation, numerous specific details are set forth in order to provide a thorough understanding of the present invention. It will be apparent; however, to one skilled in the art that the present invention may be practiced without some of these specific details. In addition, the following description provides examples, and the accompanying drawings show various examples for the purposes of illustration. However, these examples should not be construed in a limiting sense as they are merely intended to provide examples of embodiments of the invention rather than to provide an exhaustive list of all possible implementations. In other instances, well-known structures and devices are shown in block diagram form in order to avoid obscuring the details of the disclosed features of various described embodiments.

In the following description, certain terminology is used to describe particular features of the invention. For instance, as stated above, the term “electronic device” is generally defined so as to cover all devices that require a power supply in order to operate. Common examples include a cellular telephone (cell phone) such as a Sony® Xperia™, or a portable music player with the ability to store data files or connect wirelessly to the Internet such as a Sony® Walkman® digital media player.

The term “connector” is generally defined as one end of an interconnect which is used to connect a plurality of electronic devices. For instance, a connector includes one end of a Video Graphics Array (VGA) cable, High Definition Media Interface cable (HDMI), or one end of a Universal Serial Bus (USB) extension cable. A connector may include either a receptacle or a plug. The term “receptacle” is defined generally as a port into which a plug of a connector is inserted in order to establish a connection between a first electronic device and a second electronic device or between an electronic device and a power supply. The term “plug” is defined generally as an extended portion of a first connector that is inserted into a receptacle of a second connector in order to establish a connection between a first electronic device and a second electronic device or between an electronic device and a power supply.

The term “adapter” is generally defined as a computer hardware component that acts as an intermediary between an electronic device and a connector where the adapter converts the data being transmitted through from a first form to a second form. Examples of adapters include an HDMI to VGA adapter, a Digital Video Interface (DVI) to VGA adapter, or a USB to Apple Lightning® adapter for example.

The term “cable” is defined generally as one or more interconnects configured to transmit power or data from one electronic device to another or from an electrical socket to an electronic device. An “interconnect” is any type of coupling used to establish an electrical path. Examples of an interconnect include one or more electrical wires, traces or even an optical fiber. Throughout the specification and claims, the term “cable” is used interchangeably with the term “charging cable.”

The term “contact” is defined generally as the connecting point that transfers data or power between two connectors, between a connector and an adapter, between a connector and a power supply, or between an adapter and a power supply. In one embodiment, a contact is defined as a pin found in a connector. In one example, particular type of connector may contain eight pins with each pin serving a designated purpose. For instance, the particular connector may comprise the following pin layout: pin 1 representing ground; pin 2 representing lane 0 positive; pin 3 representing lane 0 negative; pin 4 representing identification/control 0; pin 5 representing power; pin 6 representing lane 1 negative; pin 7 representing lane 1 positive; and pin 8 representing identification/control 1.

The term “power supply” is defined generally as any object that has the ability to supply electric power to an electronic device thereby charging the battery of the electronic device. For instance, a power supply may include an electrical socket, an external battery source, an automobile, or a second electronic device. An example of a second electronic device that can supply power is a personal computer. A personal computer has the ability to supply power to a first electronic device, such as a cell phone for example for example, through the use of a cable with a USB connector plugged into the personal computer and a connector plugged into a connector for this cell phone. Similarly, an automobile may supply power to an electronic device through the cigarette lighter receptacle. Today, the cigarette lighter receptacle is typically used to charge electronic devices. Throughout the specification and claims, the terms “electrical outlet” and “electrical socket” are used interchangeably.

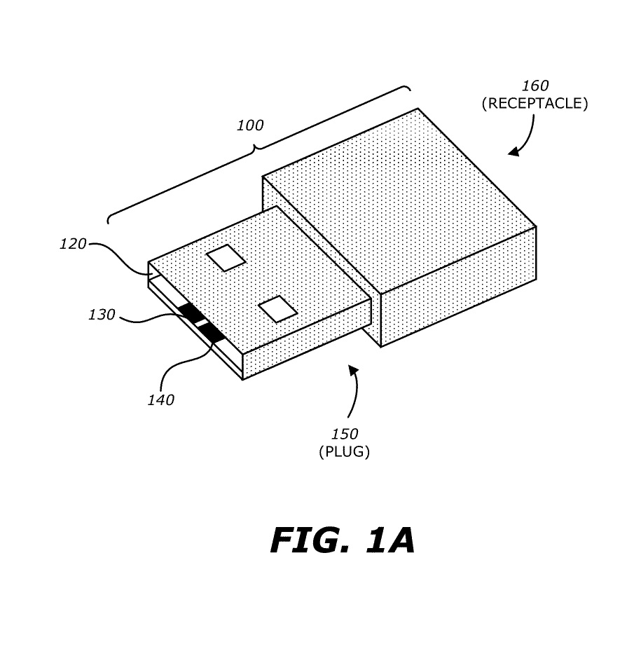

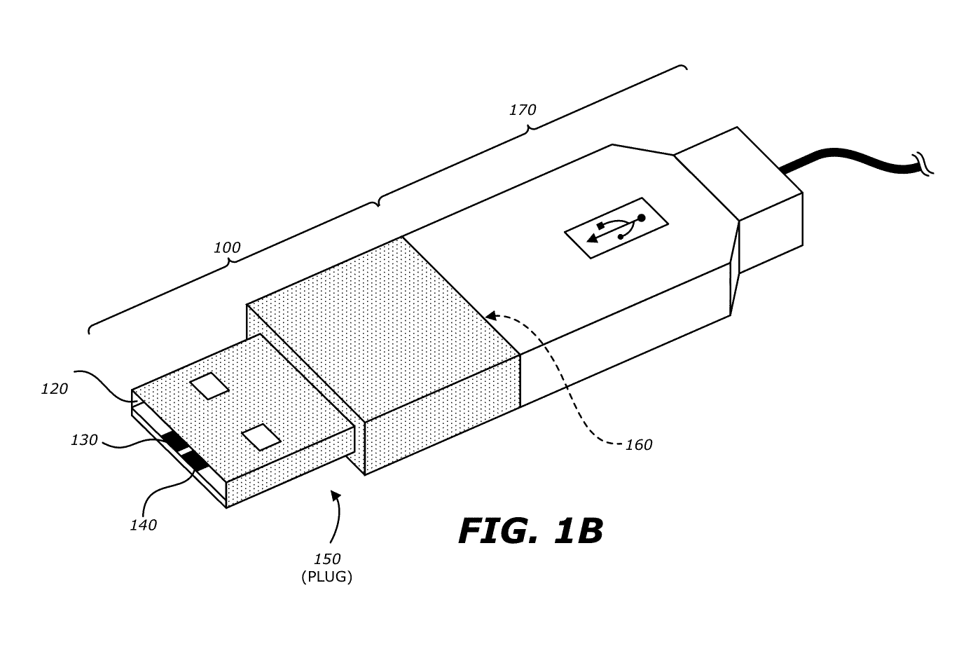

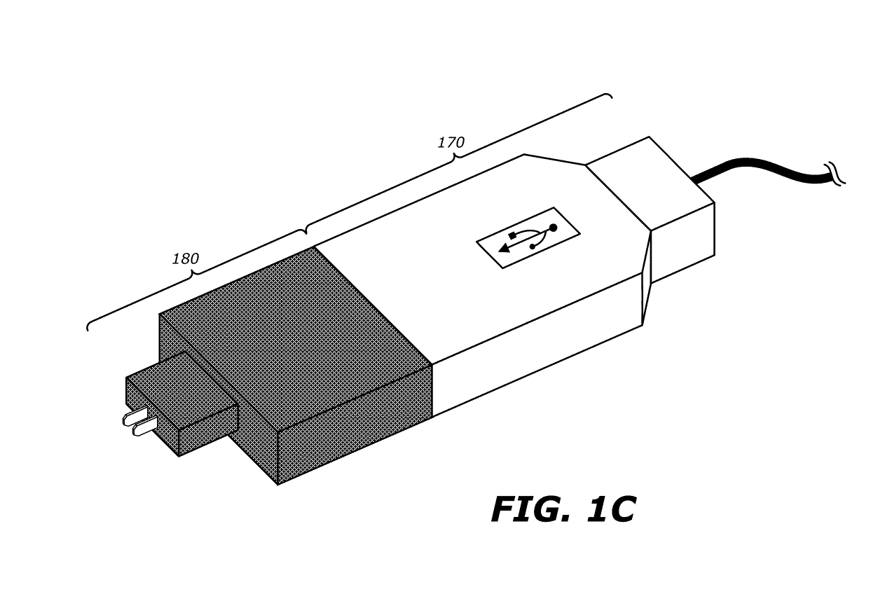

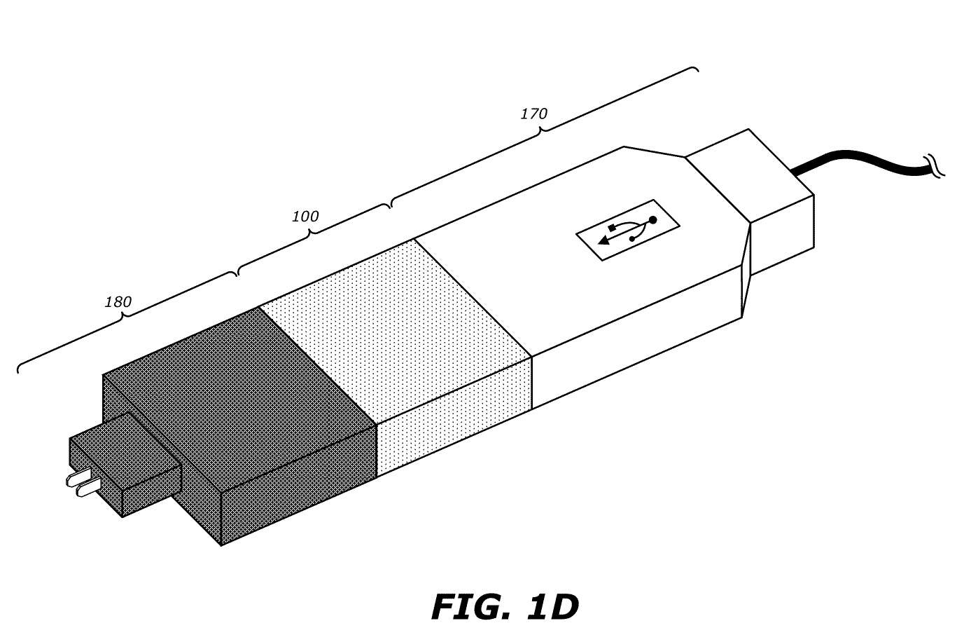

Referring to FIG. 1A, an exemplary embodiment of a physical portable adapter 100 for an electronic device is described. In FIG. 1A, the adapter 100 is depicted detached from any connector and cable combination. As shown, the adapter 100 comprises an outer housing 110 which protects the socket device 120 from debris or any object that may interfere with the contacts 130 and 140 of the adapter 100 establishing a connection with the contacts of a connector or a power supply.

A first side of the housing 110 includes a plug 150 which is used to connect to a power supply. The plug 150 may connect directly into a port of a computer, such as a desktop, a laptop or a tablet PC. The socket device 120 located inside of the plug 150 is illustrated as having a plurality of contacts such as contacts 130 and 140. The contacts 130 and 140 are used to transfer only power, not data. Alternatively, the plug 150 may connect into a connector 180, discussed later, which would enable the plug 150 to obtain a power supply directly from an electrical socket.

A second side of the housing 110, not shown, includes a receptacle 160 which is used to connect to a charging cable, such as a USB cable or a Thunderbolt™ cable. Similarly to the plug 150, the receptacle 160 will comprise a plurality of contacts, none of which will transfer data.

In another embodiment, the adapter 100 may be configured to connect with a micro-USB connector. The receptacle 160 of the adapter may contain a plurality of contacts with none being able to transfer data. In such an instance, a first contact of the receptacle may be configured to transfer +5V and a second contact of the receptacle may be configured as ground. The adapter 100 would not contain any contacts by which to transfer data between the micro-USB connector to use to establish a connection for transferring data. Therefore, although the micro-USB connector is configured to allow the transfer of data, the use of the adapter 100 prevents the transfer of data between the electronic device and the power supply.

Referring to FIG. 1B, an exemplary embodiment of adapter 100 connected to a standard A USB connector 170 is shown. In this embodiment, the adapter 100 is configured to connect to a standard A USB cable. The plug of the USB connector 170 connects to the receptacle 160 of the adapter 100 in order to establish a connection. As in FIG. 1A, the socket device 120 contains a plurality of contacts, contacts 130 and 140. One contact, contact 130 for example, of plug 150 would be configured to transfer +5V and the other contact, contact 140, would be configured as ground. Therefore, in such an embodiment, when the adapter 100 is connected to the USB cable which is connected to an electronic device, the adapter 100 prevents the transfer of any data between the electronic device and the power supply as adapter 100 contains no contacts by which the transfer of data may occur. This in turn prevents the uploading of any malware to the electronic device and prevents personal data from being accessed. Other embodiments of similar power supplying connectors are also envisioned. For example, the adapter 100 may be instead configured to connect to a connector of the electronic device, which permits the flow of data through the USB cable but restricts the flow of such data through the connector. For instance, if the adapter 100 provides coupling to a Lightning® connector, six of the eight Lightning® connector contacts would be left unconnected to anything in the adapter 100 and only two contacts would be used, one to transfer +5V and one configured as ground.

The idea envisioned in the embodiment depicted in FIGS. 1A and 1B is becoming critical for ensuring that the security of a user's electronic device is not compromised, especially when charging the electronic device in an unknown charging station. Examples of an unknown charging station include USB, micro-USB, or mini-USB charging stations located in airports, hotel rooms, bus terminals, common areas of universities or colleges, etc. Such a charging station may even be present in the armrest of an airplane seat or of a bus seat. Taking the example of a USB charging station in an airport terminal, a user of an electronic device may be waiting to board a flight but have 45 minutes until she will be able to board. During this time period, the user may decide to utilize a charging station to charge her electronic device, a cell phone for example. She may obtain a charge, for a small fee or for free depending on the charging station, if she plugs one end of a USB charging cable into an available USB port in the charging station and the other end into her cell phone's charging port.

The user likely believes that her cell phone may just be obtaining a charge of its battery; however, she may not have noticed a third party device plugged into the USB port inside the charging station. This third party device may contain malware that will be uploaded and installed onto the cell phone during the charge. There is no minimum time that malware takes to upload to an electronic device and it is conceivable that the process of uploading and installing malware may only take a moment or even a few seconds. As described above, the malware may infect the electronic device by exploiting vulnerabilities of the software on the phone. The malware may be installed on the device even if the device is password protected. However, the use of the adapter 100 prevents any possibility of an attack on an electronic device through the unwanted uploading of malware or firmware because the adapter 100 contains a plurality of contacts configured to transfer power and no contacts that may transfer data. Therefore, the infectious malware or firmware present on the third party device will be unable to be uploaded and installed onto the user's electronic device.

Similarly, an issue with using an automobile as a power supply may arise with rental cars. Although the personal automobile of an electronic device user will be a trusted location, the user has no knowledge of prior drivers in a rental car. This unanimity gives hackers an excellent opportunity to install a small device in a rental car and innocuously upload malware from an electronic device disguised as a charging port while the user's device is being charged. The adapter 100 provides a suitable means for a user to protect himself or herself from such hackers.

Referring to FIG. 1C, an exemplary embodiment of a standard A USB connector 170 connected to an adapter 180 configured to connect to an electrical socket is depicted. An adapter such as adapter 180 is well-known in the art. The plug of the USB connector plugs into the receptacle of the adapter 180. An electrical socket then supplies power to an electronic device connected to the USB connector 170 through the adapter 180. The adapter 180 contains a standard socket device, not shown, configured to connect to a USB connector which contains four contacts to allow all four contacts of the USB connector 170 to establish a connection.

Referring to FIG. 1D, an exemplary embodiment of a standard A USB connector 170 is connected to a first adapter 100 and the first adapter 100 is connected to a second adapter 180. The first adapter 100, which was described previously in accordance with FIG. 1A, includes a plurality of contacts to transfer only power. The second adapter 180 was described in accordance with FIG. 1C. The plug of the USB connector 170 plugs into the receptacle 160, not shown, of the adapter 100. The plug 150, not shown, of the first adapter 100 plugs in the receptacle of the second adapter 180. An electronic device obtains power from the USB connector 170 as power is supplied through the first adapter 100 and the second adapter 180 when the second adapter 180 is plugged into an electrical socket. One of the advantages of this approach is that the user's existing USB cables may be used with the proposed adapter.

In an alternative exemplary embodiment to the adapter 100 of FIGS. 1A-1D, an adapter may be configured to connect to a USB connector, contain one or more contacts (e.g. two contacts for transferring data, one contact for transferring +5V and one contact configured as ground) and include a switch to control whether data is transmitted.

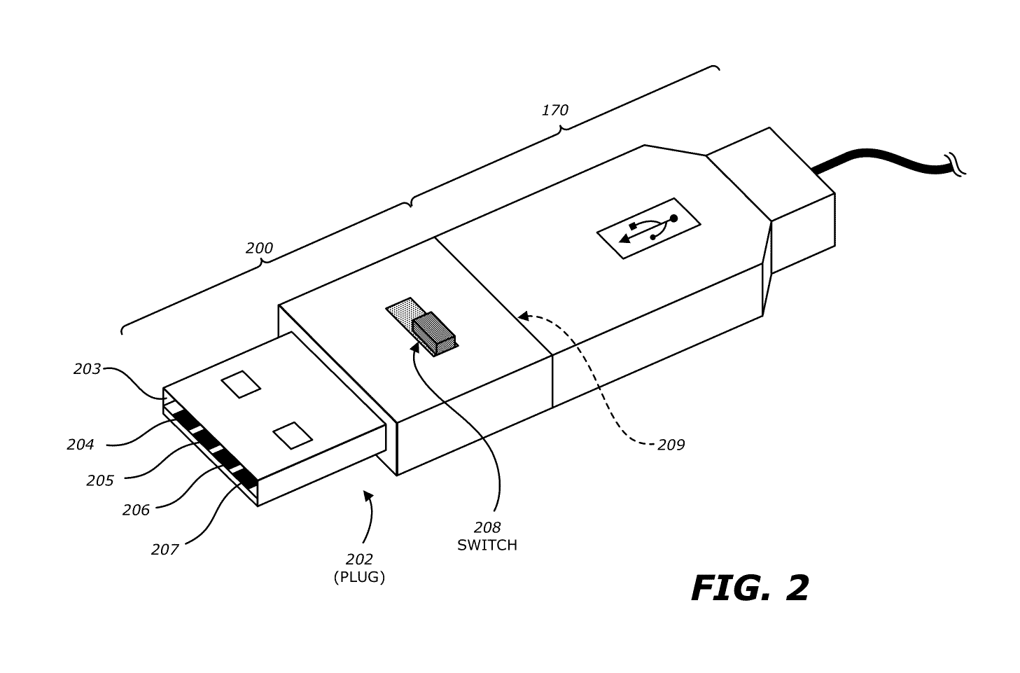

Referring to FIG. 2, an embodiment of a portable adapter including a switch connected to a standard A Universal Serial Bus (USB) connector is depicted. The adapter 200 includes a plug 202, a socket device 203 which include a plurality of contacts, for example, contacts 204, 205, 206 and 207, a switch 208, and a receptacle 209. At least one contact would be configured to transfer data, for example contacts 205 and 206 and at least one contact would be configured to transfer power, for example contact 204 and at least one contact would be configured as ground, for example contact 207. The adapter 200 would allow an electronic device coupled to the adapter 200 to charge by permitting a transfer of power through, for example, a USB cable 170. However, the adapter 200 would conditionally limit the transmission of data through the adapter 200 depending upon the position of a switch 208. If the switch 208 on the adapter 200 is placed in a “transmit” or “closed” position, the adapter 200 would allow the transmission of data. However, if the switch 208 is placed in an “off” or “open” position, the adapter 200 would prevent the transmission of data. The switch 208 could be built into the connector housing of one end of a charging cable. If the charging station is trusted, e.g., the user's desktop computer, then the switch 208 would allow the transmission of data. When travelling, and using unknown charging sources, the switch 208 would be in the “off” position and the contacts configured to transfer data, for example, contacts 205 and 206, would not be operable.

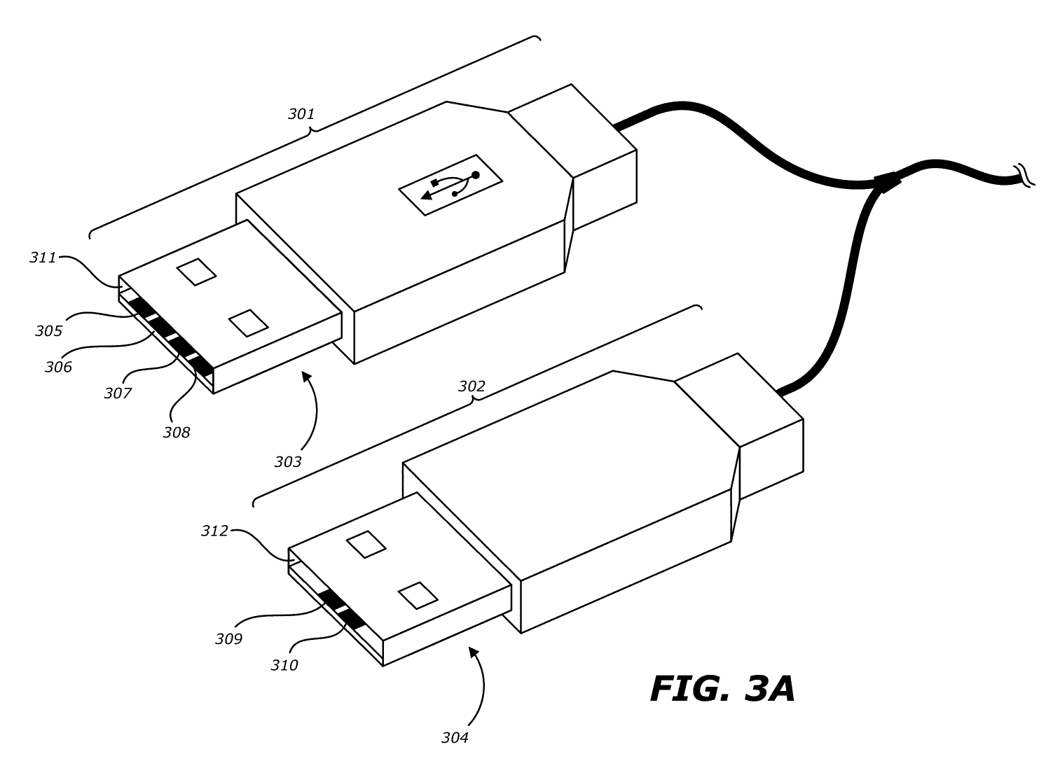

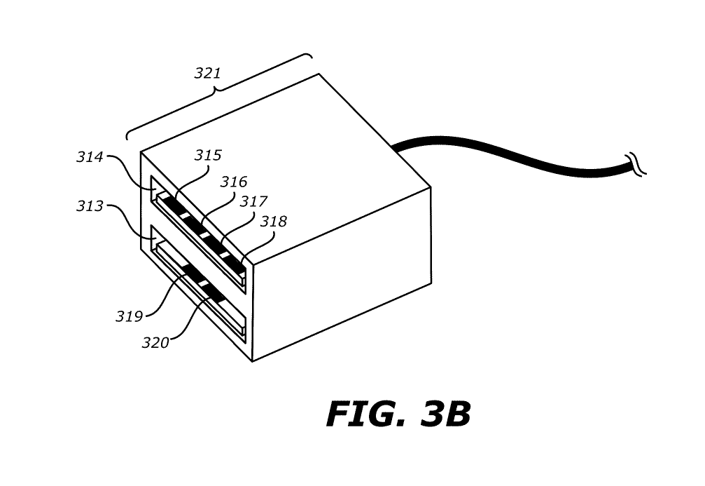

In an alternative exemplary embodiment to the adapter 100 of FIGS. 1A-1D, a USB cable may be configured with a plurality of plugs. Referring to FIG. 3A, an embodiment of a cable including a plurality of adapters is depicted. In FIG. 3A, a first adapter 301 includes a plug 303, a socket device 311 which includes a plurality of contacts, contacts 305, 306, 307 and 308. The embodiment of a cable in FIG. 3A also includes a second adapter 302 which includes a plug 304, a socket device 312 which includes a plurality of contacts, contacts 309 and 310. At least one adapter, for example, adapter 301, may contain contacts to transfer data, for example contacts 306 and 307, while at least one adapter, for example, adapter 302, would not. In this scenario, a receptacle, not shown, may contain contacts for data but those contacts for data would not be used unless the appropriate adapter, for example, adapter 301, was used. The user can select which adapter on the cable to use when plugging in to a charging station.

Referring to FIG. 3B, an embodiment of a cable including an adapter comprising a plurality of receptacles is depicted. In FIG. 3B, an adapter 321 is shown comprising a plurality of receptacles, receptacles 314 and 315. At least one receptacle, for example, receptacle 314, may have at least one contact, for example, contacts 316 and 317, to transfer data while at least one receptacle, for example, receptacle 315, does not. In the scenario having a plurality of receptacles, a plug, not shown, attached to the cable would contain data contacts but they would not be used unless the appropriate receptacle, for example, receptacle 314, was used.

In the exemplary embodiments illustrated in FIGS. 3A and 3B, such a cable would allow an electronic device coupled to the cable to charge by permitting the transfer of power. However, the cable would conditionally limit the transmission of data through the adapter depending upon which plug or receptacle the user selected to utilize.

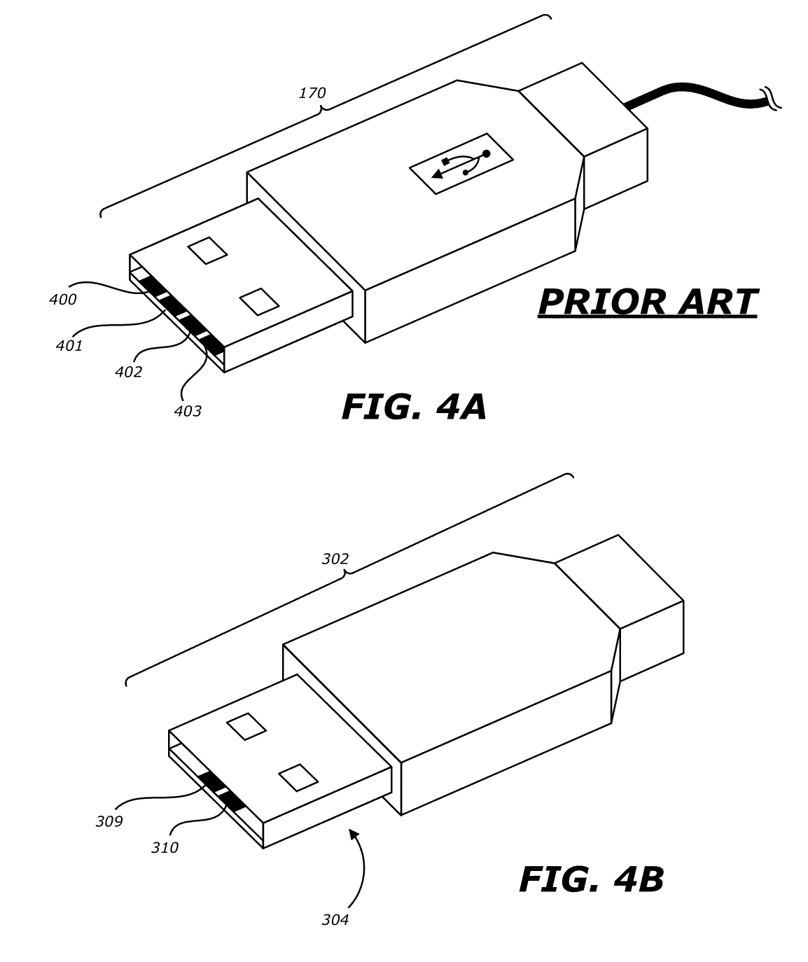

In FIG. 4A, a conventional, standard A USB connector 170 is depicted. The connector 170 contains four contacts: 400, 401, 402 and 403. Two contacts will be used to transmit power from the USB connector 170 to an electronic device and two contacts will be used to transfer data between the USB connector and the electronic device. In contrast, as shown in FIG. 4B, an exemplary embodiment of a modified connector having a plurality of contacts is illustrated. In contrast to the USB connector 170, as seen in FIG. 4A, connector 406 contains only two contacts: 404 and 405. In such an embodiment, the contacts 404 and 405 would only be used to transmit power and therefore enable connector 406 to prevent the transmission of data. The cable connected to the connector 406 would only require two interconnects, one transmitting +5V and one configured as ground. As an alternative to the adapter 100 depicted in FIG. 1A, a user could connect the connector 406 to an electronic device in order to ensure the security of the electronic device was not compromised while the electronic device was charging. Alternative embodiments are also envisioned and FIG. 4B should not be construed as limiting the idea. For instance, a connector such as connector 406 may include more than two contacts. Furthermore, it is also envisioned that various voltages may be supplied to an electronic device in accordance with the spirit of the invention.

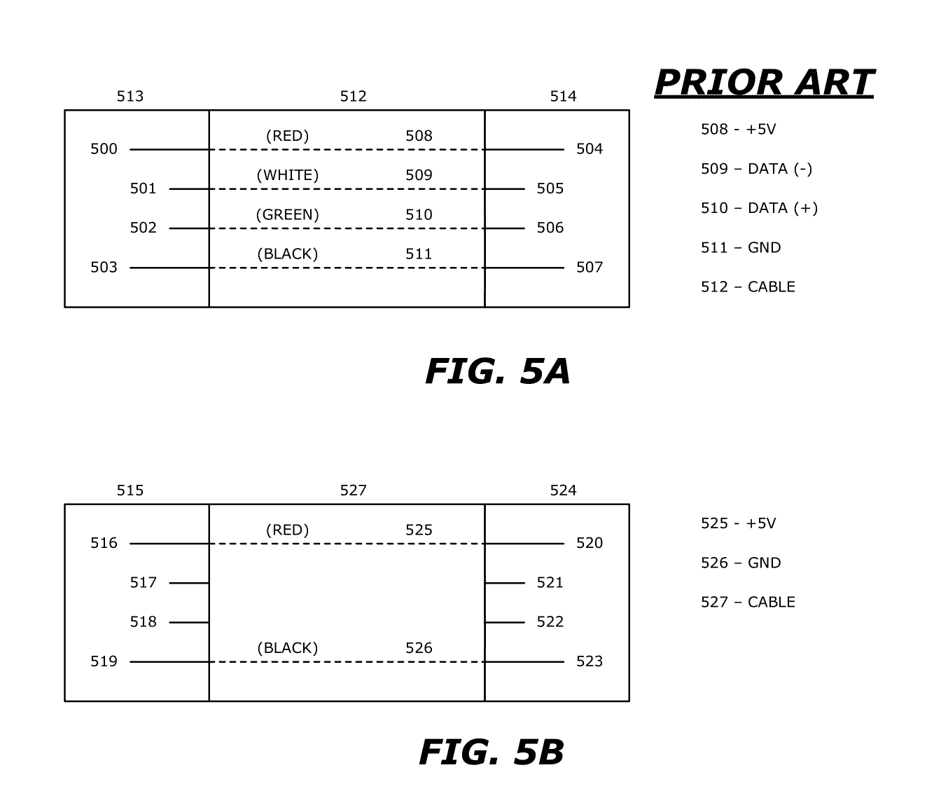

Referring to FIG. 5A, a box diagram illustrating the pinout of a standard A USB cable is depicted. Block 513 represents a first connector of the cable and includes four contacts: 500, 501, 502 and 503. Block 514 represents the second connector of the cable and also contains four contacts: 504, 505, 506 and 507. Block 512 represents the cable connecting the two connectors 513 and 514. The transmission of power and data from the first connector to the second connector occurs over the four wires found inside the cable represented by the dotted lines 508-511. Wire 508 connects contacts 500 and 504 and transmits +5V. Wire 509 connects contacts 501 and 505 and transmits data (−). Wire 510 connects contacts 502 and 506 and transmits data (+). Wire 511 connects contacts 503 and 507 and represents ground. As is known in the art, this standard configuration of a USB connector and cable combination allows an electronic device to connect to a power supply to obtain either just a supply of power (e.g., from an electrical socket) or to obtain a supply of power while transmitting data (e.g., from a personal computer).

Referring to FIG. 5B, a box diagram illustrating the pinout of the connector 406, as illustrated in FIG. 4B, is depicted. No interconnects are present within the cable by which to transmit data. Block 527 represents the cable and blocks 515 and 524 represent the two connectors on either side of the cable 527. Interconnect 525 connects contacts 516 and 520 and transmits +5V. Interconnect 526 connects contacts 519 and 523 and is configured as ground. A user of an electronic device could charge the device with the particular cable and connector combination depicted in FIGS. 4B and 5B and not allow for the opportunity for malware to be uploaded to the electronic device while it is charging. As we stated above, alternative embodiments are also envisioned and FIG. 5B should not be construed as limiting the idea. For instance, a cable such as cable 527 may include more than two interconnects. Furthermore, it is also envisioned that various voltages may be supplied to an electronic device in accordance with the spirit of the invention.

Preventing or controlling data transmission through software has also been envisioned. In one embodiment, an application would be installed on an electronic device, the application would recognize that a connector has been plugged into the electronic device, and would take action in one of the ways to be described below. The application may prevent the electronic device from acknowledging any attempt to transmit data between the connector and the electronic device. The application may be configured to limit the transmission of certain data or prevent the transmission of all data. The prevention of the transmission of all data could include the prevention of a unique identifier of the electronic device being transmitted through the connector and to the power supply.

The prevention of the transmission of data may be provided for at multiple levels of the Open Systems Interconnection (OSI) model developed by the International Organization for Standardization (ISO). In one embodiment, the data transmission may be controlled at layer 1, the physical layer. For example, the application may block the transmission of any communication requests from being received by the electronic device on which the application is running. Alternatively, the application may prevent the transmission of data at OSI Layer 2, the data link layer. In the data link layer, the application may detect the media access control (MAC) address of the power supply, if applicable, and determine whether the MAC address of the power supply has been previously designated as a trusted source by the user of the electronic device. If the MAC address of the power supply has previously been trusted, the application may elect to bypass alerting the user through a notification 600, described below, and allow the transmission of data. Alternatively, if the MAC address has not been trusted previously by the user, the application may prompt the user with a notification 600. Furthermore, the application may allow the user to remove an individual power supply or all power supplies from the stored list of trusted power supplies.

Of course, other identifiers besides the MAC address may be used for determining whether the power supply is trusted or not. For instance, in lieu of the MAC address, an Organizationally Unique Identifier (OUI) may be used for merely providing the identification of the manufacturer of the device, where certain manufacturers are preselected as trusted sources. Similarly, cryptographic data such as a digital certificate, digital signature or even a hash value may be used as an identifier.

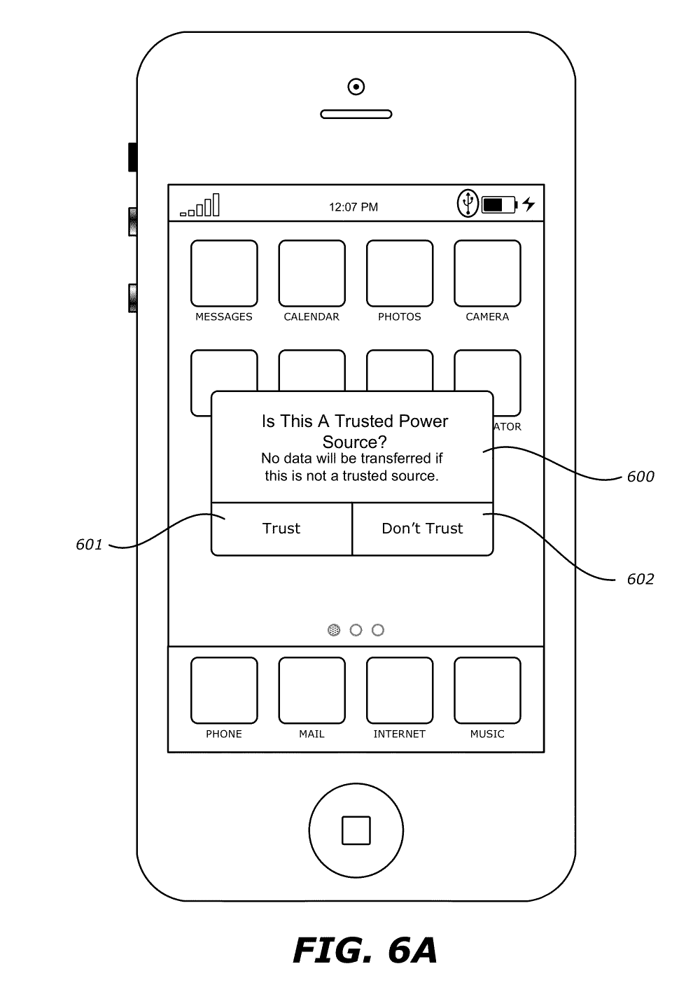

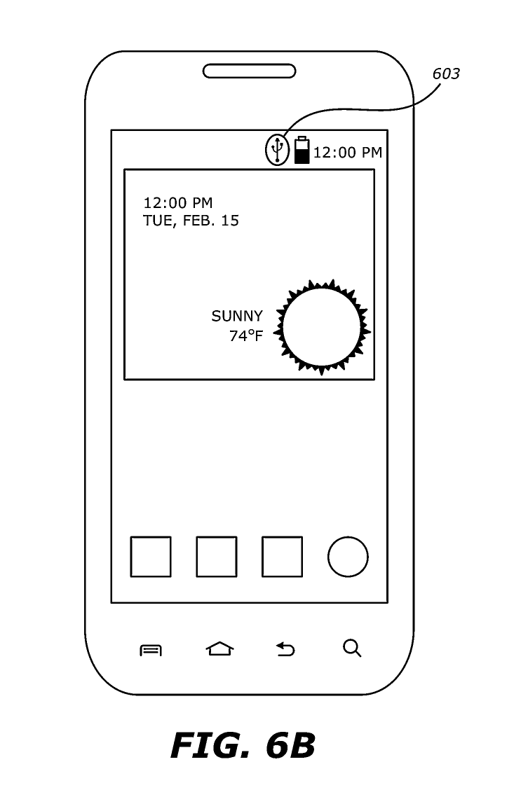

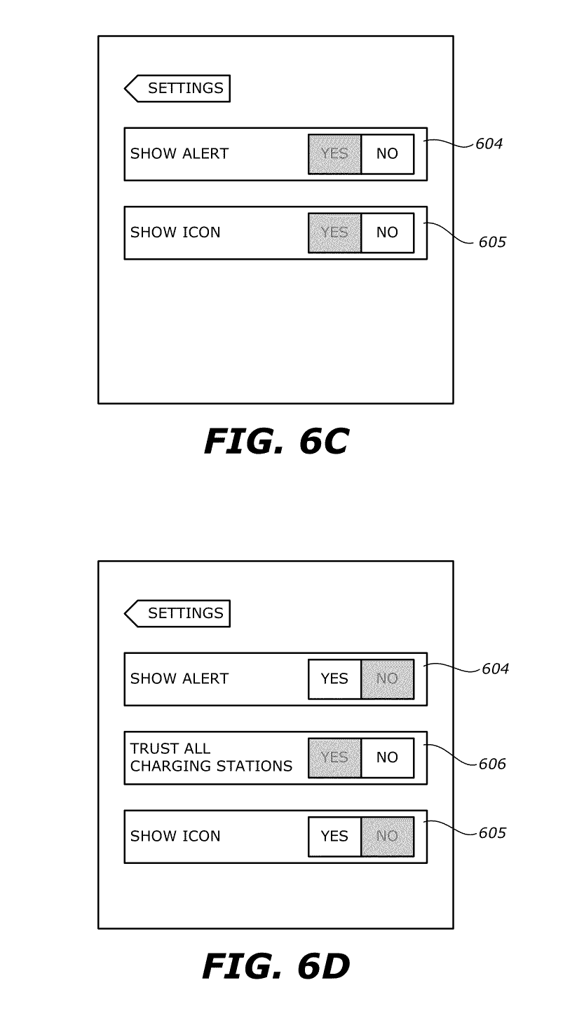

Referring to FIG. 6A, an exemplary embodiment of a notification of an application to prevent the transmission of data between a cell phone and an untrusted power supply is depicted. FIG. 6A illustrates one embodiment of a notification 600 presented to a user of a cell phone. The notification 600 notifies the user that the cell phone has been connected to a power supply and may require the user to select whether the power supply is trusted. The user selects whether the power supply is trusted by tapping either button 601 reading “Trust,” or button 602 reading “Don't Trust.” If the user selects to trust the power supply, the application will permit the transmission of data between the cell phone and the connector. However, if the user does not select to trust the device, the application can prevent the transmission of all data between the cell phone and the connector. The term “trusted” should be construed to mean that the user desires to permit the transfer of data between the user's electronic device and the power supply in issue. Conversely, the term “untrusted” should be construed to mean that the user does not want to permit the transfer of data between the user's electronic device and the power supply in issue. It is envisioned that the notification 600 may be accompanied by the playing of a unique sound, a vibration, or a combination thereof, to ensure that the user is alerted to the notification 600.

The notification 600 may be a pop-up that automatically appears on the front of the screen as soon as the electronic device is connected to a connector associated with a power supply. Alternatively, the application may not contain a notification but instead require the user to set a default course of action to be taken by the application and either trust all power supplies or regard all power supplies as being untrusted. In yet another embodiment, the application may have a notification 600 but allow the user to disable the notification 600 and require the application to behave according to a default course of action. It should be noted that although a cell phone is depicted is FIG. 6A, the envisioned application is applicable to other electronic devices, such as a Sony® Xperia™ Tablet Z.

Referring to FIG. 6B, an exemplary embodiment of an illustration of a cell phone having an icon representing that the application to prevent the transmission of data between an electronic device and an untrusted power supply is running is depicted. In one embodiment, the icon 603 is depicted as a standard USB symbol inside of an oval. This is only one possible illustration and the icon 603 could be depicted as any symbol such that it notifies the user of the electronic device that the application is running. The icon 603 could be any figure, object, or picture symbolizing that the application is running. Furthermore, the icon 603 does not have to be located in the upper right-hand corner of the screen. It should be noted that although a cell phone is depicted is FIG. 6B, the envisioned application is applicable to other electronic devices, such as a Sony® Xperia™ Tablet Z.

Referring to FIG. 4C, an exemplary embodiment of a box diagram of a screen illustrating the “Settings” menu of an electronic device is depicted. The box 604 represents the “SHOW ALERT” option which allows the user to choose whether a notification 600 will be displayed on the screen when a power supply is connected to the electronic device through a connector. The box 605 represents the “SHOW ICON” option which allows the user to choose whether an icon 603 is displayed on the screen notifying the user that the application is running.

Referring to FIG. 4D, an exemplary embodiment of a box diagram of the “Settings” screen of an electronic device is depicted. In FIG. 4D, the box 604 representing the “SHOW ALERT” option is set to “NO” as contrasted with the box 604 being set to “YES” in FIG. 4C. In FIG. 4D, with box 604 set to “NO,” box 606, representing the “TRUST ALL CHARGING STATIONS” option, appears. Box 606 gives the user the ability to bypass the presence of the notification 600 each time the electronic device is connected to a power supply and prevent data transmission whenever the electronic device is connected to a power supply. This represents the user's ability to configure the default settings of the application. Other default settings for the application have been envisioned. Examples of other default settings include whether the application plays a sound or vibrates to signify that the application is running or that a notification 600 has appeared on the screen. Box 605 representing the “SHOW ICON” option is also depicted as being in the “NO” position.

It is to be understood that even though numerous characteristics and advantages of various embodiments of the present invention have been set forth in the foregoing description, together with details of the structure and function of various embodiments of the invention, this disclosure is illustrative only. In some cases, certain subassemblies are only described in detail with one such embodiment. Nevertheless, it is recognized and intended that such subassemblies may be used in other embodiments of the invention. Changes may be made in detail, especially matters of structure and management of parts within the principles of the embodiments of the present invention to the full extent indicated by the broad general meaning of the terms in which the appended claims are expressed.

Having disclosed exemplary embodiments and the best mode, modifications and variations may be made to the disclosed embodiments while remaining within the scope of the embodiments of the invention as defined by the following claims.

What is claimed is:

1. A portable adapter for an electronic device charging apparatus comprising:
a housing unit including a first plug and a first receptacle; and
a socket device including a first side, a second side and a first plurality of contacts, the socket device being placed within and extending through the housing unit between the first plug and the first receptacle and being configured to connect to a power supply through the first side and configured to connect to the electronic device through the second side,
wherein the first plurality of contacts of the socket device are configured so that none of the first plurality of contacts allow for the transfer of data and at least one of the first plurality of contacts is configured for a transfer of power.

2. The portable adapter of claim 1 further comprising a switch that, when operating in a first state, configures the first plurality of contacts so that none of the first plurality of contacts allow for the transfer of data and at least one of the first plurality of contacts is configured for a transfer of power.

3. The portable adapter of claim 2, wherein the switch that, when operating in a second state, configures the first plurality of contacts so that at least one of the first plurality of contacts is configured to transfer data and at least one of the first plurality of contacts is configured to transfer power.

4. The portable adapter according to claim 1, wherein the connector is a multi-pin connector including one of a Universal Serial Bus (USB) connector, a micro-USB connector, a mini-USB, a Lightening interface or a Thunderbolt interface connector.

5. The portable adapter according to claim 1, wherein the socket device is configured to include contacts that are only capable of transferring power.

6. The portable adapter according to claim 1, wherein the housing unit further includes a second receptacle and the socket device extends between the first receptacle, the second receptacle and the first plug,
wherein the first plurality of contacts are coupled to the first receptacle, the second plurality of contacts are coupled to the second receptacle, and at least one of the second plurality of contacts allows the transfer of data and at least one of the second plurality of contacts is configured for a transfer of power.

7. A non-transitory computer readable medium comprising instructions, which when executed by one or more hardware processors, cause performance of operations comprising:
determining that an electronic device has been connected to an unregistered power supply;
notifying, on a display screen of the electronic device, a user to confirm that the unregistered power supply is a trusted power supply; and
disabling the transfer of all data wherein the user denies the unregistered power supply is trusted and permitting the transfer of data wherein the user confirms the unregistered power supply is trusted.

8. The non-transitory computer readable medium according to claim 7 further comprising:
extracting a unique identifier from the power supply if the power supply attempts to transfer data between the power supply and the electronic device;
storing the unique identifier according to whether the user denied or confirmed that the power supply is trusted; and
registering the power supply if the user confirms the power supply is trusted, wherein the user will not be notified that the electronic device has been connected to the power supply if the power supply is trusted.

9. The non-transitory computer readable medium according to claim 7 wherein an icon is displayed on a display screen of the electronic device notifying the user whether the connector is a trusted source.

10. The non-transitory computer readable medium according to claim 7 wherein the electronic device plays a unique sound when the user is notified that the electronic device has been connected to the connector.

11. The non-transitory computer readable medium according to claim 7 wherein the user may configure the electronic device to automatically trust every power supply.

12. A portable electronic device charging apparatus comprising:
an interconnect;
a first housing unit coupled to a first end of the interconnect, the first housing unit comprising a first connector;
a second housing unit coupled to a second end of the interconnect, the second housing unit comprising a second connector;
a first socket device includes a first plurality of contacts, the first socket device, extending through the first housing unit between the first connector and the interconnect, wherein the first plurality of contacts are configured so that none of the first plurality of contacts allows for the transfer of data and at least one of the first plurality of contacts is configured for a transfer of power; and
a second socket device includes a second plurality of contacts, the second socket device, extending through the second housing unit between the second connector and the interconnect, wherein the second plurality of contacts are configured so that none of the second plurality of contacts allows for the transfer of data and at least one of the second plurality of contacts is configured for a transfer of power.

13. The electronic device charging apparatus according to claim 12 wherein the connector is one of a Standard-A type USB connector, a micro-USB connector, a mini-USB, a Lightening interface or a Thunderbolt interface connector.

14. The electronic device charging apparatus according to claim 12 wherein the first connector includes one of a plug or a receptacle.

15. The electronic device charging apparatus according to claim 14 wherein the second connector includes one of a plug or a receptacle.

16. The electronic device charging apparatus according to claim 15 further comprising:
a third housing unit coupled to the first end of the interconnect, the third housing unit comprising a third connector; and
a third socket device placed including a third plurality of contacts, the third socket device extending through the third housing unit between the third connector and the interconnect, wherein the third plurality of contacts are configured so that at least one of the third plurality of contacts allows for the transfer of data and at least one of the third plurality of contacts is configured for a transfer of power.

17. The electronic device charging apparatus according to claim 16 wherein the third connector includes one of a plug or a receptacle.

18. The electronic device charging apparatus according to claim 12, wherein the first housing unit includes a third connector and a third socket device, wherein
the third socket device includes a third plurality of contacts, the third socket device, extending through the first housing unit between the third connector and the interconnect, wherein the third plurality of contacts are configured so that none of the third plurality of contacts allows for the transfer of data and at least one of the third plurality of contacts is configured for a transfer of power.
